(19) United States
(12) Patent Application Publication
(10) Pub. No.: US 2021/0211621 A1
(43) Pub. Date: Jul. 8, 2021

(54) INFORMATION PROCESSING APPARATUS, INFORMATION PROCESSING METHOD, AND PROGRAM

(71) Applicant: SONY CORPORATION, TOKYO (JP)

(72) Inventors: FUMIHIKO IIDA, KANAGAWA (JP); KENTARO IDA, TOKYO (JP); TAKUYA IKEDA, TOKYO (JP)

(21) Appl. No.: 17/059,919

(22) PCT Filed: May 24, 2019
(86) PCT No.: PCT/JP2019/020704

§ 371 Date: Nov. 30, 2020

(30) Foreign Application Priority Data
Jun. 6, 2018 (JP) 2018-108449

(51) Int. Cl. H04N 9/31; G03B 21/14

(52) U.S. Cl. CPC H04N 9/3185; H04N 9/3155; G03B 21/14

(57) ABSTRACT

An information processing apparatus including a control unit (150) configured to control a projection process of notification information including posture control of a projection device (121) on the basis of spatial information of a space (30) where the projection device can perform projection, information indicating the position and the posture of the projection device, information indicating confidentiality of the notification information, information of a first user who is a notification target of the notification information, and information of a second user who is not a notification target of the notification information.

### TECHNICAL FIELD

The present disclosure relates to an information processing apparatus, an information processing method, and a program.

### BACKGROUND ART

In recent years, as the performance of a projection device that projects information on a wall surface or the like has improved, the projection device is being used for notification of various information.

For example, Patent Document 1 below discloses a technology of notifying a user of information by using a projection device (so-called moving projector) capable of changing the posture (that is, changing the projection direction).

### CITATION LIST

### Patent Document

### Patent Document 1: Japanese Patent Application Laid-Open No. 2017-054251

### SUMMARY OF THE INVENTION

### Problems to be Solved by the Invention

Information that the user is notified of can include information with high confidentiality. In performing notification of information with high confidentiality, it is desirable that at least other user cannot visually recognize the information. Furthermore, it is desirable that the other user does not notice the state where the projection device is being driven to change the posture. Changing the posture of the projection device may indicate to other user that notification of certain information may be performed, and furthermore may attract the eyes of the other user to the information with high confidentiality.

Therefore, the present disclosure provides a mechanism capable of controlling the posture of a projection device in accordance with confidentiality of information that a user is notified of.

### Solution to Problems

According to the present disclosure, there is provided an information processing apparatus including a control unit configured to control a projection process of notification information including posture control of a projection device on the basis of spatial information of a space where the projection device can perform projection, information indicating the position and the posture of the projection device, information indicating confidentiality of the notification information, information of a first user who is a notification target of the notification information, and information of a second user who is not a notification target of the notification information.

Furthermore, according to the present disclosure, there is provided an information processing method including causing a processor to control a projection process of notification information including posture control of a projection device on the basis of spatial information of a space where the projection device can perform projection, information indicating the position and the posture of the projection device, information indicating confidentiality of the notification information, information of a first user who is a notification target of the notification information, and information of a second user who is not a notification target of the notification information.

Moreover, according to the present disclosure, there is provided a program for causing a computer to function as a control unit configured to control a projection process of notification information including posture control of a projection device on the basis of spatial information of a space where the projection device can perform projection, information indicating the position and the posture of the projection device, information indicating confidentiality of the notification information, information of a first user who is a notification target of the notification information, and information of a second user who is not a notification target of the notification information.

### Effects of the Invention

As described above, the present disclosure provides a mechanism capable of controlling the posture of the projection device in accordance with confidentiality of information that the user is notified of. Note that the effects described above are not necessarily limited, and along with or in lieu of the effects described above, any of the effects described in the present Description, or another effect that can be grasped from the present Description may be exhibited.

### BRIEF DESCRIPTION OF DRAWINGS

FIG. 1 is a view illustrating an overview of an information processing system according to an embodiment of the present disclosure.

FIG. 2 is a block diagram illustrating an example of a configuration of the information processing system according to the embodiment.

FIG. 3 is a diagram for explaining an example of setting a projection target area by the information processing system according to the embodiment.

FIG. 4 is a diagram for explaining an example of setting a projection target area by the information processing system according to the embodiment.

FIG. 5 is a diagram for explaining an example of setting a projection target area by the information processing system according to the embodiment.

FIG. 6 is a diagram for explaining an example of setting a projection target area in a first case according to the embodiment.

FIG. 7 is a diagram for explaining an example in which notification information is projected in the first case according to the embodiment.

FIG. 8 is a diagram for explaining an example of setting a projection target area in a second case according to the embodiment.

FIG. 9 is a diagram for explaining an example in which notification information is projected in the second case according to the embodiment.

FIG. 10 is a diagram for explaining an example in which notification information is projected in the second case according to the embodiment.

FIG. 11 is a diagram for explaining an overview of a third case according to the embodiment.

FIG. 12 is a diagram for explaining an example in which notification information is projected in the third case according to the embodiment.

FIG. 13 is a diagram for explaining an example in which notification information is projected in the third case according to the embodiment.

FIG. 14 is a diagram for explaining posture control in the third case according to the embodiment.

FIG. 15 is a flowchart illustrating an example of the overall flow of a projection process executed by the information processing system according to the embodiment.

FIG. 16 is a flowchart illustrating an example of a flow of a posture control process in the third case executed by the information processing system according to the embodiment.

FIG. 17 is a diagram for explaining a projection process according to a modification.

FIG. 18 is a diagram for explaining posture control according to the modification.

### MODE FOR CARRYING OUT THE INVENTION

Hereinafter, a preferred embodiment of the present disclosure will be described in detail with reference to the accompanying drawings. Note that in the present Description and the drawings, the same reference signs denote constituents having substantially the same functional configuration and an overlapping description will be omitted.

Note that the description will be given in the following order.

1 Overview

1.1. Overall configuration example

1.2. Overview of proposed technology

2. Device configuration example

3. Details of projection process

3.1. First case

3.2. Second case

3.3. Third case

4. Process flow

5. Modifications

6. Summary

<<1. Overview>>

<1.1. Overall Configuration Example>

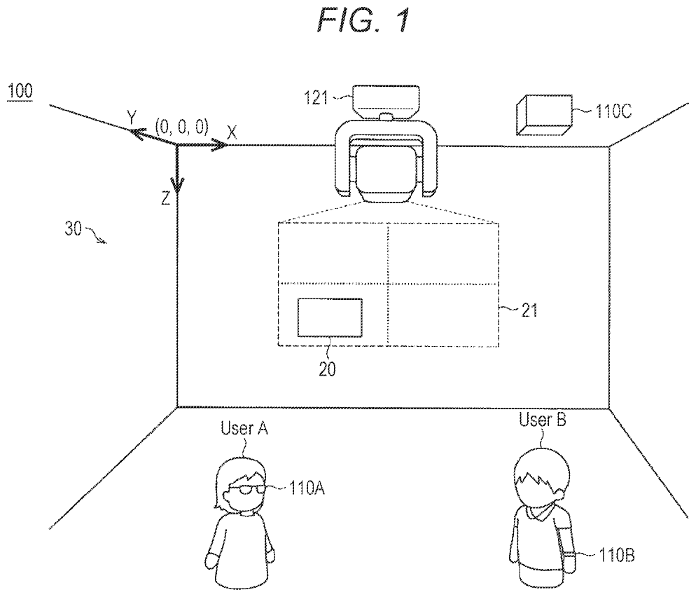

FIG. 1 is a view illustrating an overview of an information processing system according to an embodiment of the present disclosure. As illustrated in FIG. 1, an information processing system 100 according to the present embodiment includes an input unit 110 (110A to 110C) and an output unit 120. The input unit 110 and the output unit 120 are disposed in a physical space 30.

The physical space 30 is a real space in which users (users A and B) can move inside. The physical space 30 may be a closed space such as an indoor space or an open space such as an outdoor space. At least, the physical space 30 is a space in which information can be projected by a projection device. The coordinates in the physical space 30 are defined as the coordinates on coordinate axes, that is, the Z axis whose axial direction is the vertical direction and the X axis and the Y axis having the horizontal plane as the XY plane. It is assumed that the origin of the coordinate system in the physical space 30 is, for example, a vertex on the ceiling side of the physical space 30.

A projector 121 is a projection device that visually notifies the user of various information by mapping and displaying the various information on any surface of the physical space 30. As the projector 121, a projector (so-called moving projector) capable of changing the posture (that is, changing the projection direction) is used. In the example illustrated in FIG. 1, the projector 121 is disposed in an upper part of the physical space 30, for example, in a state of being hung from the ceiling, and projects a display object 20 at any location within a projectable area 21 of the projector 121. The projectable area 21 is a range in which an image can be projected at one time, the range being determined by an optical system of the projector 121. That is, the projectable area 21 is an area on which the projector 121 can project an image in the current posture (that is, without changing the posture). In the present Description, “current” is a timing at which it is determined whether or not the posture of the projector 121 needs to be changed, and is, for example, a timing before the posture is changed. The projector 121 can set any location in the physical space 30 within the projectable area 21 by changing the posture. The projector 121 projects an image on a projection target area. The projection target area is an area on which an image which is a projection target is projected. The projection target area is set to any location in the physical space 30, any size, and any shape. The projection target area is also regarded as an area where the display object 20 is projected. The size and the shape of the projection target area may or may not match the size and the shape of the projectable area 21. In other words, the projector 121 can project the display object 20 on entirety of the projectable area 21, and can project the display object 20 on part of the projectable area 21. In a case where the projection target area is not included in the projectable area 21 in the current posture of the projector 121, the projector 121 projects an image after changing the posture so that the projection target area is included in the projectable area 21. The posture change includes pan/tilt control for changing the angle of the projector 121, translational movement control for changing the position of the projector 121, and the like. The translational movement is realized, for example, by attaching the optical system of the projector 121 to an arm or the like having a joint and capable of performing rotational movement and bending movement, and rotating/bending such an arm.

The input unit 110 is a device for inputting information of the physical space 30 and information of the user. The input unit 110 can be realized as a sensor device that senses various information. The input units 110A and 110B are user-worn sensor devices. In the example illustrated in FIG. 1, the input unit 110A is an eyewear type wearable terminal worn by the user A, and the input unit 110B is a wristband type wearable terminal worn by the user B. Each of the input units 110A and 110B includes an acceleration sensor, a gyro sensor, an imaging device, and/or a biological information sensor, or the like, and senses the condition of the user. Furthermore, the input unit 110C is an environment-installed sensor device. In the example illustrated in FIG. 1, the input unit 110C is provided in the upper part of the physical space 30 in a state of being hung from the ceiling. The input unit 110 includes, for example, an imaging device whose imaging target is the physical space 30, and/or a depth sensor or the like that senses depth information, and senses the condition of the physical space 30.

The information processing system 100 outputs information with any location in the physical space 30 as an output location. First, the information processing system 100 acquires information inside the physical space 30 by analyzing information input by the input unit 110. The information inside the physical space 30 is information regarding the shape and arrangement of a real object such as a wall, a floor, or furniture in the physical space 30, information regarding the user, and the like. Then, the information processing system 100 sets the projection target area of the display object on the basis of the information inside the physical space 30, and projects the display object on the projection target area that has been set. For example, the information processing system 100 can project the display object 20 on the floor, a wall surface, the top surface of a table, or the like. In a case where a so-called moving projector is used as the projector 121, the information processing system 100 realizes control of such an output location by changing the posture of the projector 121.

A configuration example of the information processing system 100 according to the present embodiment has been described above.

<1.2. Overview of Proposed Technology>

Information that the user is notified of can include information with high confidentiality. In performing notification of information with high confidentiality, it is desirable that at least other user cannot visually recognize the information. Furthermore, it is desirable that the other user does not notice the state where the projection device is being driven to change the posture. Note that in the present Description, driving of the projection device refers to driving performed to change the posture of the projection device, such as pan/tilt mechanism driving, unless otherwise specified.

Changing the posture of the projection device may indicate to other user that notification of certain information may be performed, and furthermore may attract the eyes of the other user to the information with high confidentiality. Attracting the eyes of the other users as described above is also referred to as a gaze attraction effect below. Considering that there is possibility that information with high confidentiality is notified, it is desirable that posture control of the projection device is performed in consideration of the gaze attraction effect.

Therefore, the present disclosure provides a mechanism capable of controlling the posture of a projection device in accordance with confidentiality of information that a user is notified of. Such a mechanism will be described with reference to FIG. 1.

Assume a case where a user existing in the physical space 30 is notified of information. The information that the user is notified of is also referred to as notification information below. The notification information can include an image (still image/moving image) and/or text or the like. A user who is a notification target of the notification information is also referred to as a first user. A user who is not the notification target of the notification information is also referred to as a second user. In the example illustrated in FIG. 1, it is assumed that the user A is the first user and the user B is the second user.

When the information processing system 100 acquires notification information that the user A should be notified of, the information processing system 100 generates a display object on the basis of the notification information and projects the display object that has been generated on the physical space 30 to perform notification of the notification information. In the example illustrated in FIG. 1, the information processing system 100 causes the projector 121 to project the display object 20 generated on the basis of notification information for the user A to notify the user A of the notification information. Hereinafter, in a case where it is not necessary to particularly distinguish between notification information and a display object that is generated on the basis of the notification information and projected, the notification information and the display object are also collectively referred to as notification information.

In a case where confidentiality of notification information is high, it is desirable that the notification information that has been projected is visible only to the user A and not visible to the user B. Furthermore, in consideration of the gaze attraction effect, it is desirable that the user B does not visually recognize the state where the projector 121 is driven to project the notification information on the location visually recognized only by the user A. Therefore, the information processing system 100 imposes a restriction on driving, such as not driving the projector or driving the projector at a low speed, in a case where the projector 121 is within the visible range of the user B. Therefore, the state where the projector 121 is driven cannot be or less likely to be visually recognized by the user B. As a result, it is possible to avoid the occurrence of an unintended gaze attraction effect and to ensure confidentiality of notification information. For example, privacy of the user A is protected.

Moreover, for example, the user A does not have to move far away from the user B in order to receive notification of notification information with high confidentiality, which improves convenience.

Posture control of the projector 121 in consideration of the gaze attraction effect is beneficial not only to the user A but also to the user B. This is because if the user B sees the state in which the projector 121 is driven, attention of the user B is distracted by the projector 121. In this case, there are disadvantages such as interruption of work performed by the user B. In this regard, by performing posture control of the projector 121 in consideration of the gaze attraction effect, it is possible to avoid giving a disadvantage to the user B who is not the notification target of notification information.

The overview of the proposed technology has been described above. The details of the proposed technology will be described below.

<<2. Device Configuration Example>>

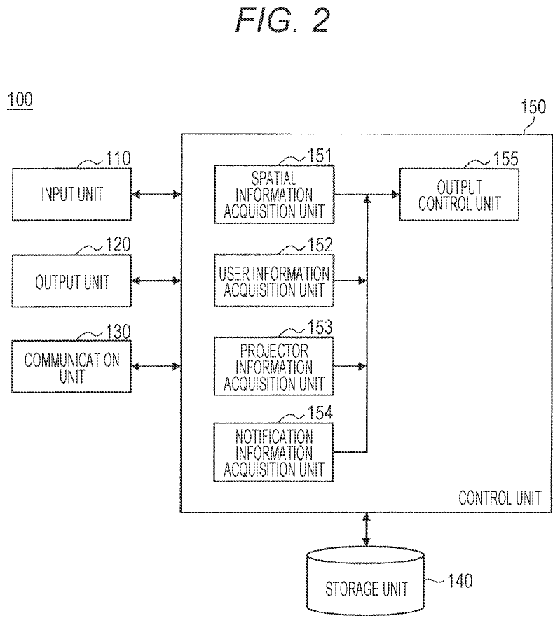

FIG. 2 is a block diagram illustrating an example of a configuration of the information processing system 100 according to the present embodiment. As illustrated in FIG. 2, the information processing system 100 includes the input unit 110, the output unit 120, a communication unit 130, a storage unit 140, and a control unit 150. Note that the information processing system 100 may be realized as one device or may be realized as a plurality of devices.

(1) Input Unit 110

The input unit 110 has a function of inputting information of the user or the physical space. The input unit 110 can be realized by various input devices.

For example, the input unit 110 can include an imaging device. The imaging device includes a lens system, a drive system, and an imaging element, and captures an image (still image or moving image). The imaging device may be a so-called optical camera or a thermographic camera that can also acquire temperature information.

For example, the input unit 110 can include a depth sensor. The depth sensor is a device that acquires depth information, such as an infrared ranging device, an ultrasonic ranging device, a time of flight (ToF) system ranging device, laser imaging detection and ranging (LiDAR), or a stereo camera.

For example, the input unit 110 can include a sound collecting device (microphone). The sound collecting device is a device that collects ambient sound and outputs audio data converted into a digital signal via an amplifier and an analog digital converter (ADC). The sound collecting device collects, for example, user voice and environment sound.

For example, the input unit 110 can include an inertial sensor. The inertial sensor is a device that detects inertial information such as acceleration or angular velocity. The inertial sensor is worn by the user, for example.

For example, the input unit 110 can be realized as a biosensor. The biosensor is a device that detects biological information such as heartbeat or body temperature of the user. The biosensor is worn by the user, for example.

For example, the input unit 110 can include an environment sensor. The environment sensor is a device that detects environment information such as brightness, temperature, humidity, or atmospheric pressure in the physical space.

For example, the input unit 110 can include a device that inputs information on the basis of physical contact with the user. Examples of such a device include a mouse, a keyboard, a touch panel, a button, a switch, and a lever. These devices can be installed in a terminal device such as a smartphone, a tablet terminal, or a personal computer (PC).

The input unit 110 inputs information on the basis of control performed by the control unit 150. For example, the control unit 150 can control the zoom ratio and the imaging direction of the imaging device.

Note that the input unit 110 may include one of these input devices or a combination thereof, or may include a plurality of input devices of the same type.

Furthermore, the input unit 110 may include a terminal device such as a smartphone, a tablet terminal, a wearable terminal, a personal computer (PC), or a television (TV).

(2) Output Unit 120

The output unit 120 is a device that outputs information to the user. The output unit 120 can be realized by various output devices.

The output unit 120 includes a display device that outputs visual information. The output unit 120 maps visual information on a surface of a real object and outputs the visual information. An example of such an output unit 120 is the projector 121 illustrated in FIG. 1. The projector 121 is a so-called moving projector such as a pan/tilt drive type including a movable unit capable of changing the posture (that is, changing the projection direction). In addition, the output unit 120 may include as a display device that outputs visual angle information, a fixed projector, a display such as a liquid crystal display (LCD) or an organic light emitting diode (OLED), electronic paper, a head mounted display (HMD), or the like.

The output unit 120 can include an audio output device that outputs auditory information. Examples of such an output unit 120 include a speaker, a directional speaker, an earphone, a headphone, and the like.

The output unit 120 can include a haptic output device that outputs haptic information. The haptic information is, for example, vibration, force sense, temperature, electrical stimulation, or the like. Examples of the output unit 120 that outputs haptic information include an eccentric motor, an actuator, a heat source, and the like.

The output unit 120 can include a device that outputs olfactory information. The olfactory information is, for example, a scent. Examples of the output unit 120 that outputs olfactory information include an aroma diffuser and the like.

The output unit 120 outputs information on the basis of control performed by the control unit 150. For example, the projector 121 changes the posture (that is, the projection direction) on the basis of control performed by the control unit 150. Furthermore, the directional speaker changes the directivity on the basis of control performed by the control unit 150.

In the present embodiment, the output unit 120 includes at least the projector 121 including the movable unit whose posture can be changed. The output unit 120 may include a plurality of projectors 121, and may include another display device, an audio output device, or the like in addition to the projector 121.

Furthermore, the output unit 120 may include a terminal device such as a smartphone, a tablet terminal, a wearable terminal, a personal computer (PC), or a television (TV).

(3) Communication Unit 130

The communication unit 130 is a communication module for transmitting and receiving information to and from another device. The communication unit 130 performs wired/wireless communication in compliance with any communication standard such as, for example, a local area network (LAN), a wireless LAN, Wireless Fidelity (Wi-Fi, registered trademark), infrared communication, or Bluetooth (registered trademark).

For example, the communication unit 130 receives notification information and outputs the notification information to the control unit 150.

(4) Storage Unit 140

The storage unit 140 has a function of temporarily or permanently storing information for operating the information processing system 100. The storage unit 140 stores, for example, spatial information, condition information, posture information, notification information, and/or information related to the notification information as described later.

The storage unit 140 is realized by, for example, a magnetic storage device such as an HDD, a semiconductor storage device, an optical storage device, a magneto-optical storage device, or the like. The storage unit 140 may include a storage medium, a recording device that records data in the storage medium, a reading device that reads data from the storage medium, a deleting device that deletes data recorded in the storage medium, and the like.

(5) Control Unit 150

The control unit 150 functions as an arithmetic processing unit and a control device, and controls the overall operation of the information processing system 100 according to various programs. The control unit 150 is realized, for example, by an electronic circuit such as a central processing unit (CPU), or a microprocessor. Furthermore, the control unit 150 may include a read only memory (ROM) that stores a program to be used, a calculation parameter, and the like, and a random access memory (RAM) that temporarily stores a parameter that appropriately changes and the like.

As illustrated in FIG. 2, the control unit 150 functions as a spatial information acquisition unit 151, a user information acquisition unit 152, a projector information acquisition unit 153, a notification information acquisition unit 154, and an output control unit 155.

(5.1) Spatial Information Acquisition Unit 151

The spatial information acquisition unit 151 has a function of acquiring information of the physical space (hereinafter also referred to as spatial information) on the basis of information input by the input unit 110. The spatial information acquisition unit 151 outputs the spatial information that has been acquired to the output control unit 155. The spatial information will be described below.

The spatial information can include information indicating the type and arrangement of a real object in the physical space. Furthermore, the spatial information can include identification information of the real object. For example, the spatial information acquisition unit 151 acquires such information by recognizing the captured image. In addition, the spatial information acquisition unit 151 may acquire such information on the basis of the read result of an RFID tag attached to the real object in the physical space. Furthermore, the spatial information acquisition unit 151 may also acquire such information on the basis of user input. Note that examples of the real object in the physical space include a wall, a floor, furniture, and the like.

The spatial information can include three-dimensional information indicating the shape of the space. The three-dimensional information indicating the shape of the space is information indicating the shape of the space defined by real objects in the physical space. For example, the spatial information acquisition unit 151 acquires three-dimensional information indicating the shape of the space on the basis of depth information. In a case where information indicating the type and arrangement of real objects in the physical space and identification information of the real objects can be acquired, the spatial information acquisition unit 151 may acquire three-dimensional information indicating the shape of the space in consideration of such information.

The spatial information can include information of the material, the color, the texture, or the like of a surface forming the space (for example, a surface of a real object such as a wall, a floor, furniture, or the like). For example, the spatial information acquisition unit 151 acquires such information by recognizing the captured image. In a case where information indicating the type and arrangement of the real object in the physical space and identification information of the real object can be acquired, the spatial information acquisition unit 151 may acquire information of the material, the color, the texture, or the like in consideration of such information.

Spatial information can also include information regarding conditions within the physical space, such as brightness, temperature, and humidity of the physical space. For example, the spatial information acquisition unit 151 acquires such information on the basis of environment information.

The spatial information includes at least one of the pieces of information described above.

(5.2) User Information Acquisition Unit 152

The user information acquisition unit 152 has a function of acquiring information of the user (hereinafter also referred to as user information) on the basis of information input by the input unit 110. The user information acquisition unit 152 outputs the user information that has been acquired to the output control unit 155. The user information will be described below.

The user information can include whether or not there is a user in the physical space, the number of users in the physical space, and identification information of each user. For example, the user information acquisition unit 152 acquires such information by recognizing the face part of the user included in the captured image.

The user information can include attribute information of the user. The attribute information is information indicating attributes of the user such as age, sex, job, family structure, or friendship. For example, the user information acquisition unit 152 acquires attribute information of the user on the basis of the captured image or by using the identification information of the user to make an inquiry to the database that stores the attribute information.

The user information can include information indicating the position of the user. For example, the user information acquisition unit 152 acquires information indicating the position of the user on the basis of the captured image and the depth information.

The user information can include information indicating the posture of the user. For example, the user information acquisition unit 152 acquires information indicating the posture of the user on the basis of the captured image, the depth information, and the inertial information. The posture of the user may refer to the posture of the whole body such as standing still, standing, sitting, or lying down, or the posture of part of the body such as the face, the torso, a hand, a foot, or a finger.

The user information can include information indicating the visible range of the user. For example, the user information acquisition unit 152 identifies the positions of the eyes and the line-of-sight direction of the user on the basis of on the captured image including the eyes of the user and the depth information, and acquires information indicating the visible range of the user on the basis of such information and the spatial information. Information indicating the visible range is information indicating which location in the physical space is included in the field of view or the field of view of the user. Note that the field of view is a range visible without moving the eyes. The field of view may mean the central field of view, or may mean the central field of view and the peripheral field of view. The field of view is a range that is visible by moving the eyes. In addition, the presence of an obstacle is also taken into consideration in acquisition of the information indicating the visible range. For example, the back of an obstacle as viewed from the user is outside the visible range.

The user information can include information indicating activity of the user. For example, the user information acquisition unit 152 acquires information indicating activity of the user on the basis of biological information of the user. For example, activity is low during sleep or at the time of falling asleep, and the activity is high in other cases.

The user information can include information indicating motion of the user. For example, the user information acquisition unit 152 recognizes motion of the user by any method such as an optical method using an imaging device or an imaging device and a marker, an inertial sensor method using an inertial sensor worn by the user, or a method using depth information, and thus acquires information indicating motion of the user. The motion of the user may refer to motion of using the whole body such as movement, or motion of partially using the body such as a gesture with a hand. Furthermore, as the user information, user input to a screen displayed by mapping on any surface of the physical space as described above with reference to FIG. 1 is also acquired as information indicating motion of the user.

The user information can include information input with voice by the user. For example, the user information acquisition unit 152 can acquire such information by voice-recognizing a speaking voice of the user.

The user information includes at least one of the pieces of information described above.

(5.3) Projector Information Acquisition Unit 153

The projector information acquisition unit 153 has a function of acquiring information regarding the projector 121. The projector information acquisition unit 153 outputs projector information that has been acquired to the output control unit 155. The projector information will be described below.

The projector information includes information indicating the location where the projector 121 is installed. For example, the projector information acquisition unit 153 acquires information indicating the position of the projector 121 on the basis of setting information in installation of the projector 121 or on the basis of a captured image of the projector 121.

The projector information includes information indicating the posture of the projector 121. For example, the projector information acquisition unit 153 may acquire information indicating the posture from the projector 121, or may acquire information indicating the posture of the projector 121 on the basis of a captured image of the projector 121. The information indicating the posture is information indicating the current posture of the projector 121, and includes, for example, current pan angle information and tilt angle information of the projector 121. Furthermore, in a case where the projector 121 makes translational movement, the information indicating the posture also includes information indicating the current position of the projector 121. Specifically, the current position of the projector 121 is the current absolute position of the optical system of the projector 121, or the current relative position of the optical system of the projector 121 with respect to the position where the projector 121 is installed. Note that since the output control unit 155 controls the posture of the projector 121 as described later, information indicating the posture of the projector 121 can be known to the output control unit 155.

The projector information can include information indicating the driving state of the projector 121. The information indicating the driving state is a driving sound or the like for changing the posture of the projector 121. For example, the projector information acquisition unit 153 acquires information indicating the driving state of the projector 121 on the basis of the detection result of the environment sensor.

(5.4) Notification Information Acquisition Unit 154

The notification information acquisition unit 154 has a function of acquiring notification information that the user is to be notified of and information related to the notification information. The notification information acquisition unit 154 outputs information that has been acquired to the output control unit 155. The notification information may be information received from the outside such as an electronic mail, or information generated due to action of the user in the physical space 30 (for example, information for navigation to a user who is moving, or the like). Information related to the notification information will be described below.

Information related to the notification information includes information for identifying the first user. Information for identifying the first user may be identification information of the first user. In this case, the first user is uniquely specified. Information for identifying the first user may also be attribute information of the user. In this case, any user who has predetermined attribute information (for example, female, age group, or the like) is specified as the first user.

Information related to the notification information includes information indicating confidentiality of the notification information (hereinafter, also referred to as confidentiality information). Confidentiality information includes information indicating the level of confidentiality and information designating the range within which notification information can be disclosed (up to friends, family, or the like). Note that examples of the information indicating the level of confidentiality includes a value indicating the degree of confidentiality, a flag indicating whether or not the notification information is information that should be kept confidential, and the like.

Information related to the notification information includes information indicating the priority of the notification information. The priority here may be regarded as an urgency. Notification information with higher priority is preferentially conveyed to the user (that is, projected).

The notification information acquisition unit 154 may acquire information for identifying the first user, confidentiality information, and information indicating the priority by analyzing the content of the notification information. The analysis target includes the sender, the recipient, the importance label of the notification information, the type of the application which has generated the notification information, the generation time (time stamp) of the notification information, and the like.

Information related to the notification information may include information for identifying the second user. Information for identifying the second user may be identification information of the second user. In this case, the second user is uniquely specified. Information for identifying the second user may be attribute information of the user. In this case, any user who has predetermined attribute information (for example, female, age group, or the like) is specified as the second user. In this case, the user other than the second user may be specified as the first user.

(5.5) Output Control Unit 155

The output control unit 155 has a function of causing the output unit 120 to output information on the basis of information acquired by the spatial information acquisition unit 151, the user information acquisition unit 152, the projector information acquisition unit 153, and the notification information acquisition unit 154. Specifically, the output control unit 155 causes the projector 121 to perform mapping so that the display object is projected on the projection target area defined on any surface in the physical space.

In particular, the output control unit 155 controls a projection process of the notification information including posture control of the projector 121 on the basis of spatial information, projector information, confidentiality information, user information of the first user, and user information of the second user. First, the output control unit 155 sets the projection target area. Next, the output control unit 155 changes the posture of the projector 121 until the notification information can be projected on the projection target area that has been set. Thereafter, the output control unit 155 causes the projector 121 to project the display object generated on the basis of the notification information on the projection target area. Hereinafter, each process will be specifically described.

Set Projection Target Area

Position of Projection Target Area

The output control unit 155 sets the position of the projection target area. The output control unit 155 sets the projection target area at a different location according to whether or not the confidentiality information satisfies a predetermined condition. The predetermined condition is that the confidentiality information indicates that the notification information is information that should be kept confidential. The case where confidentiality information satisfies the predetermined condition is a case where the confidentiality information indicates that the notification information is the information that should be kept confidential. Whether or not confidentiality information satisfies the predetermined condition can be determined according to threshold determination for determining whether or not confidentiality of the notification information is higher than a predetermined threshold, or determination using a flag or the like indicating whether or not the notification information is information that should be kept confidential. In a case where confidentiality of the notification information is higher than the predetermined threshold or a flag indicating that the notification information is information that should be kept confidential is set, it is determined that confidentiality information satisfies the predetermined condition. In the following, the fact that confidentiality information satisfies the predetermined condition is also simply referred to as confidentiality is high. In contrast, the case where confidentiality information does not satisfy the predetermined condition is a case where the confidentiality information indicates that the notification information is not the information that should be kept confidential. In a case where confidentiality of the notification information is lower than the predetermined threshold or a flag indicating that the notification information is information that should be kept confidential is not set, it is determined that confidentiality information does not satisfy the predetermined condition. In the following, the fact that confidentiality information does not satisfy the predetermined condition is also simply referred to as confidentiality is low.

Specifically, in a case where confidentiality of the notification information is high, the output control unit 155 sets the projection target area where the notification information is projected within the visible range of the first user and outside the visible range of the second user. Regarding notification information with high confidentiality, since the projection target area is set within a range that is visible only to the first user, confidentiality of the notification information can be secured.

Here, setting the projection target area within the visible range of the first user means that at least part of the projection target area overlaps with the visible range of the first user. That is, not the entire projection target area may be included within the visible range of the first user. This is because as long as the first user notices that the notification information is projected, the notification information that has been projected can attract gaze. Furthermore, setting the projection target area outside the visible range of the second user means that the projection target area and the visible range of the second user do not overlap with each other. Therefore, confidentiality of the notification information is further secured. Furthermore, it is desirable that a predetermined buffer is provided between the projection target area and the visible range of the second user so as to be separated from each other. Therefore, it is possible to keep the projection target area outside the visible range of the second user even if the second user, for example, slightly moves the posture, and confidentiality is further secured.

In contrast, in a case where confidentiality of the notification information is low, the output control unit 155 sets the projection target area where the notification information is projected within the visible range of the first user. Regarding notification information with low confidentiality, it is allowed to set the projection target area without considering the second user. That is, the projection target area may be set within the visible range of the second user. As a result, it becomes possible to increase choices of locations for setting the projection target area.

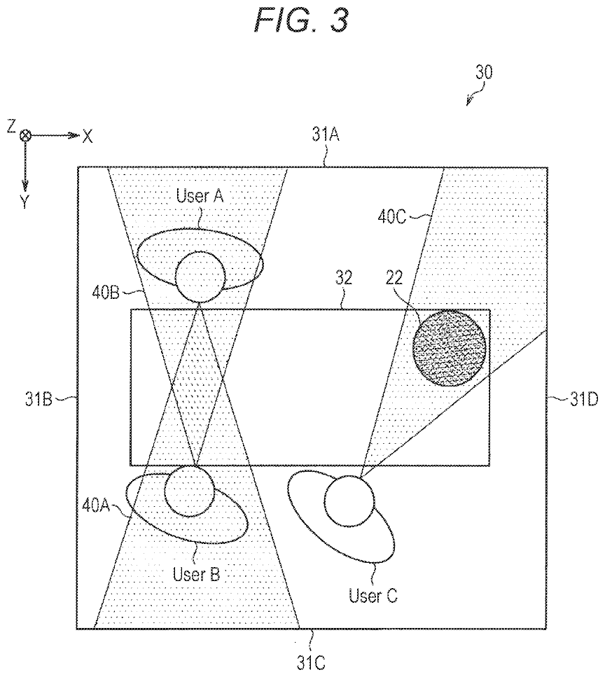

Hereinafter, an example of setting the projection target area for notification information with high confidentiality will be described with reference to FIGS. 3 to 5. FIGS. 3 to 5 are diagrams for explaining an example of setting a projection target area by the information processing system 100 according to the present embodiment. As illustrated in FIGS. 3 to 5, users A to C are located around a table 32 in the physical space 30 defined by walls 31A to 31D. FIGS. 3 to 5 illustrate states where the physical space 30 is looked down from above (that is, the Z axis positive side is viewed from the Z axis negative side).

FIG. 3 illustrates a case where confidentiality of notification information is high and only the user C is the notification target. Since the user C is the notification target, the projection target area 22 is set within the visible range 40C of the user C and outside the visible ranges 40A and 40B of the users A and B. The projection target area 22 illustrated in FIG. 3 is set in a location on the top surface (XY plane) of the table 32 included only in the visible range 40C of the user C.

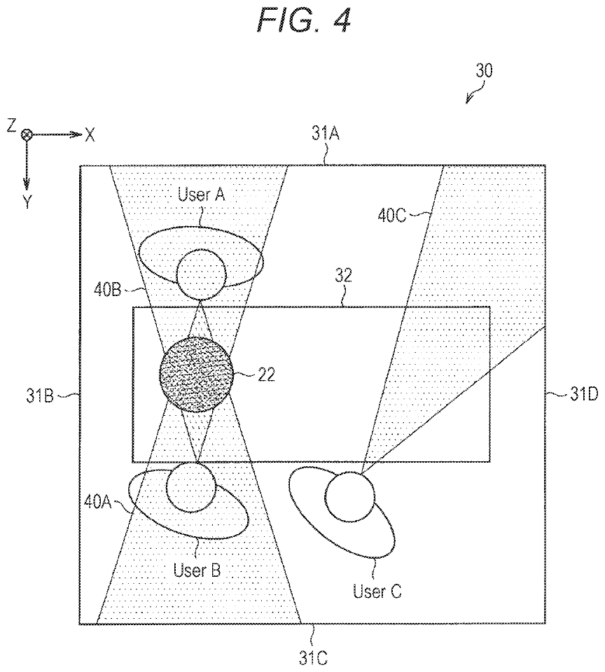

FIG. 4 illustrates a case where confidentiality of notification information is high and the users A and B are the notification targets. Since the users A and B are the notification targets, the projection target area 22 is set within the visible ranges 40A and 40B of the users A and B and outside the visible range 40C of the user C. The projection target area 22 illustrated in FIG. 4 is set in a location on the top surface of the table 32 in which the visible ranges 40A and 40B of the users A and B overlap with each other and the visible range 40C of the user C is not included.

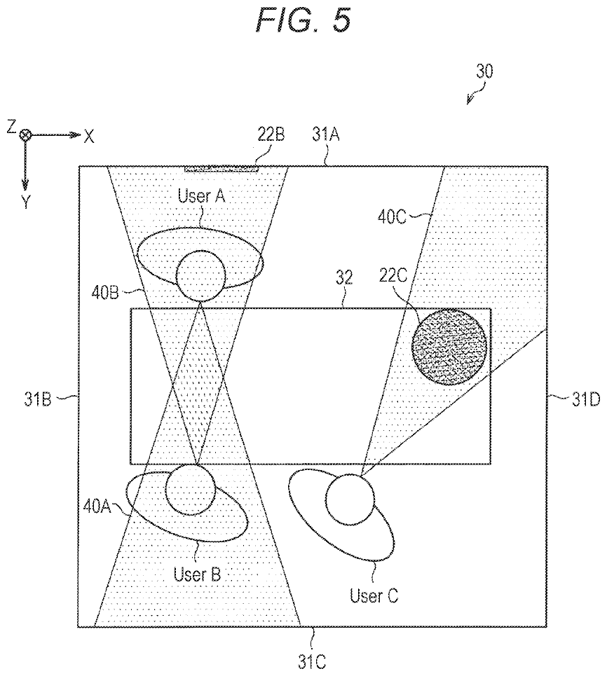

FIG. 5 illustrates a case where confidentiality of notification information is high and the users B and C are the notification targets. Since the users B and C are the notification targets, the projection target area 22 is set within the visible range 40B and 40C of the users B and C and outside the visible range 40A of the user A. However, in the example illustrated in FIG. 5, since the visible ranges 40B and 40C of the users B and C do not overlap with each other, projection target areas 22B and 22C are set individually. The projection target area 22B is set in a location on the wall 31A (XZ plane) within the visible range 40B of the user B. The projection target area 22C is set in a location on the top surface of the table 32 within the visible range 40C of the user C. Note that notification information may be simultaneously projected or may be sequentially projected on the projection target areas 22B and 22C.

Size of Projection Target Area

The output control unit 155 sets the size of the projection target area.

The output control unit 155 may set the size of the projection target area on the basis of the distance between the position of the first user and the position of the projection target area. For example, the output control unit 155 sets the projection target area smaller as the distance between the position of the first user and the position of the projection target area is smaller, and sets the projection target area larger as the distance is greater. This is to facilitate recognition of projected characters or the like.

The output control unit 155 may set the size of the projection target area on the basis of notification information. For example, the output control unit 155 sets the projection target area larger as the number of characters included in notification information increases, and sets the projection target area smaller in a case where notification information includes only simple icons.

The output control unit 155 may set the size of the projection target area on the basis of spatial information. For example, the output control unit 155 sets the size of the projection target area within the range that does not exceed the size of the surface for which the projection target area is set.

The output control unit 155 may set the size of the projection target area on the basis of projector information. For example, the output control unit 155 sets the size of the projection target area so that the projection target area falls within the current projectable area of the projector 121.

Control Posture

Next, the output control unit 155 controls the posture of the projector 121. The output control unit 155 may or may not change the posture. That is, the output control unit 155 can cause the projector 121 to project notification information without changing the posture of the projector 121 or by changing the posture of the projector 121.

The output control unit 155 sets the posture of the projector 121 to be taken in projection (hereinafter also referred to as a target posture) so that the projection target area that has been set is included in the projectable area of the projector 121. The target posture includes information indicating the pan angle, the tilt angle, and/or the position of the projector 121 that should be taken in projection. Then, the output control unit 155 performs control to change the posture of the projector 121 in a case where the target posture that has been set and the current posture of the projector 121 obtained as projector information are different from each other. The output control unit 155 may set the target posture so that the projection target area is located at the center of the projectable area. Furthermore, the output control unit 155 may set the target posture so that the projection target area is located at an end part of the projectable area.

The output control unit 155 performs posture control according to whether or not confidentiality information satisfies the predetermined condition. In a case where confidentiality of the notification information is high, the output control unit 155 imposes a restriction on changing the posture of the projector 121. Here, the restriction is to specify a driving method of the projector 121 for visually or acoustically hiding driving of the projector 121 from the second user, and a process to be executed when the projector 121 is driven. In a case where confidentiality of the notification information is high, the output control unit 155 drives the projector 121 by a predetermined driving method and executes a predetermined process. Examples of the restriction that can be imposed are described in the second and third cases of <<3. Details of projection process>> as described later. Examples of the restriction that can be imposed include stopping posture change (that is, the posture is not changed), positioning the projection target area at an end part of the projectable area, shortening the driving time (that is, reducing the posture change amount), reducing driving sound (that is, slowing driving speed for changing the posture or increasing environment sound), and the like. Other examples of the restriction that can be imposed are also described in <<5. Modifications>> to be described later. Examples of the restriction that can be imposed include returning the posture of the projector 121 to the original posture after changing the posture, darkening an indicator, controlling ambient light, and the like. By imposing such a restriction, the fact that the projector 121 is driving to project notification information with high confidentiality can be made less noticeable to the second user. Note that such a restriction is not imposed in a case where confidentiality of notification information is low.

In the case of changing the posture of the projector 121, the output control unit 155 generates a drive parameter for changing the posture and transmits the drive parameter to the projector 121. The projector 121 performs driving in the pan/tilt direction and driving in the horizontal direction or the height direction for changing the position according to such a drive parameter. The drive parameter can include information indicating the target posture of the projector 121. In this case, the projector 121 changes the pan angle, the tilt angle, and/or the position so that the posture matches the target posture. The drive parameter may include the posture change amount (the pan angle change amount, the tilt angle change amount, and the position change amount) necessary for the posture of the projector 121 to become the target posture, together with or in lieu of information indicating the target posture of the projector 121. The change amount is obtained by taking the difference between the current posture of the projector 121 obtained as projector information and the target posture that has been set. In this case, the projector 121 changes the pan angle, the tilt angle, and/or the position by the change amount. Furthermore, the drive parameter may include parameters such as drive speed of a motor for changing the posture of the projector 121, acceleration/deceleration and the rotation direction, illuminance, cooling fan strength, and the like. The output control unit 155 determines the drive parameter within a range in which stable operation of the drive mechanism of the projector 121 is realized.

Perform Projection

The output control unit 155 projects notification information on the projection target area that has been set in a case where the posture control of the projector 121 is completed. Specifically, the output control unit 155 generates a display object (that is, a projection image) on the basis of the notification information. For example, the output control unit 155 generates a display object by shaping the notification information according to the shape and the size of the projection target area. Then, the output control unit 155 causes the projector 121 to project the display object that has been generated.

Supplement

The output control unit 155 may control projecting timing. The projection timing is a concept including the timing of setting the projection target area, the timing of changing the posture of the projector 121, and timing of performing projection after posture control.

Regarding notification information whose notification target is all the users in the physical space 30, the output control unit 155 may set the projection target area at any location. In this case, the output control unit 155 projects a display object that is moving toward the set projection target area or outputs a voice instructing all the users to direct his or her eyes to the set projection target area to attract gaze to the set projection target area. Therefore, it is possible for all the users to visually recognize notification information.

The output control unit 155 may control the projection process on the basis of information indicating activity of the user. For example, in a case where activity of the first user is low, the output control unit 155 suppresses projection of notification information with low priority. In contrast, in a case where activity of the second user is low, the output control unit 155 controls the projection process without considering the second user.

The output control unit 155 may control the projection process on the basis of information indicating motion of the user. For example, in a case where the user engages in any work, the output control unit 155 suppresses projection of notification information with low priority. In contrast, in a case where the second user engages in any work, the output control unit 155 controls the projection process without considering the second user.

<<3. Details of Projection Process>>

Hereinafter, projection processes in first to third cases will be described in detail.

<3.1. First Case>

The present case is a case where confidentiality of notification information is low.

Examples of the notification information with low confidentiality include information related to all the users in the physical space 30, general-purpose information such as a weather forecast, and information to be notified additionally due to an operation performed by the user in a state where the user is recognizable to the other user. The operation performed by the user in a state recognizable to the other user is, for example, an explicit utterance to a voice agent, or the like.

It is desirable that notification information with low confidentiality is projected at a location which is most visible to the first user. Therefore, the output control unit 155 sets the projection target area at the location which is most visible to the first user on the basis of spatial information and user information of the first user.

Considering the characteristic of the projector 121 that the display characteristic is better as proceeding toward the center of the projectable area and expandability in a case where additional notification information is generated due to user operation for notification information that is projected, it is desirable that the projection target area is located at the center of the projectable area of the projector 121 in the target posture. Therefore, the output control unit 155 controls the posture of the projector 121 so that the projection target area is included in the center of the projectable area of the projector 121.

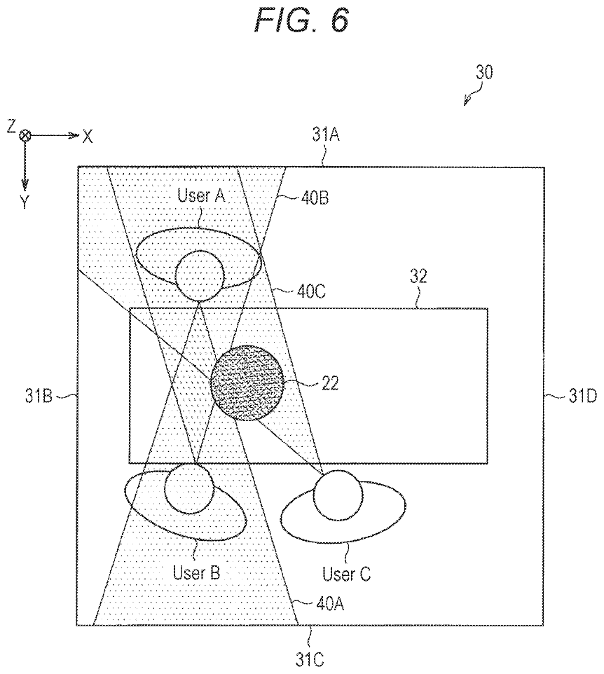

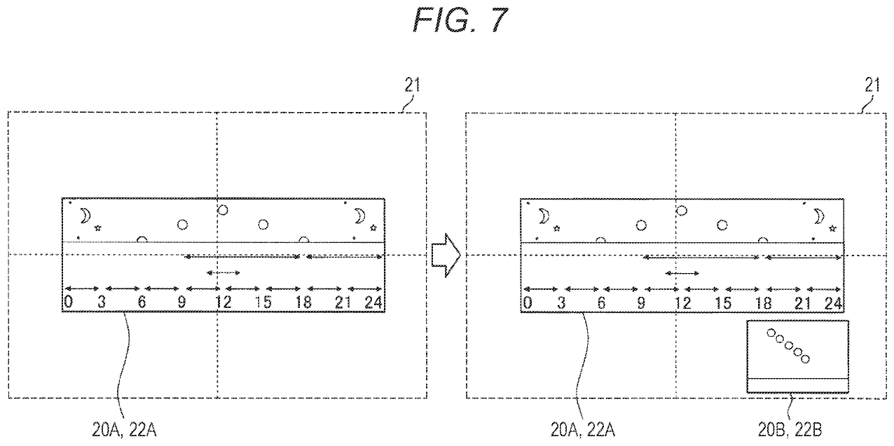

A specific example of the present case will be described with reference to FIGS. 6 and 7.

FIG. 6 is a diagram for explaining an example of setting a projection target area in the first case according to the present embodiment. As illustrated in FIG. 6, the users A to C are located facing each other around the table 32 in the physical space 30 defined by the walls 31A to 31D. FIG. 6 illustrates a state where the physical space 30 is looked down from above (that is, the Z axis positive side is viewed from the Z axis negative side).

Here, it is assumed that the user C is the notification target. However, since the confidentiality is low, the users A and B are not considered, and the projection target area 22 is set at any position within the visible range 40C of the user C. The projection target area 22 illustrated in FIG. 6 is set in a location on the top surface of the table 32 included in the visible ranges 40A to 40C of the users A to C.

FIG. 7 is a diagram for explaining an example in which notification information is projected in the first case according to the present embodiment. As illustrated in the left diagram of FIG. 7, a projection target area 22A is set at the center of the projectable area 21 of the projector 121, and a display object 20A generated on the basis of the notification information is projected. Therefore, it is possible to project the display object 20A more clearly and to ensure expandability for additional notification information. As illustrated in the right diagram of FIG. 7, in a case where notification information is additionally acquired, a projection target area 22B is set at a location not included in the projection target area 22A in the projectable area 21, and a display object 20B generated on the basis of the additional notification information is projected.

In the present specific example, since the confidentiality is low, the gaze attraction effect due to driving of the projector 121 may not be considered. Therefore, the output control unit 155 determines the drive parameter so that projection is performed quickest within a range in which stable operation of the drive mechanism of the projector 121 is realized.

Furthermore, in a case where there is another output unit 120 (for example, a display device such as a smartphone) at or near the location set as the projection target area, the output control unit 155 may cause the other output unit 120 to output notification information.

<3.2. Second Case>

The present case is a case where confidentiality of notification information is high and the projector 121 is not driven.

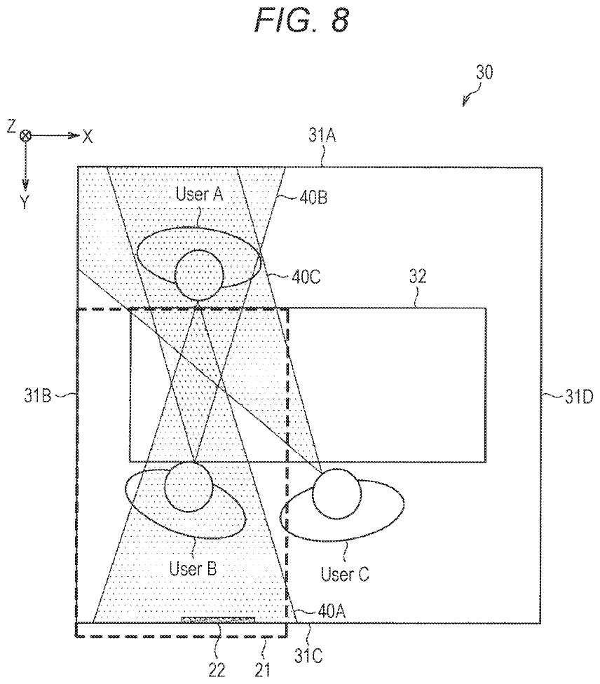

A specific example of the present case will be described with reference to FIGS. 8 to 10.

FIG. 8 is a diagram for explaining an example of setting the projection target area in the second case according to the present embodiment. As illustrated in FIG. 8, the users A to C are located facing each other around the table 32 in the physical space 30 defined by the walls 31A to 31D. FIG. 8 illustrates a state where the physical space 30 is looked down from above (that is, the Z axis front side is viewed from the Z axis negative side).

As illustrated in FIG. 8, the current projectable area 21 of the projector 121 includes the floor surface of the physical space 30, the table 32, and the walls 31B and 31C. It is assumed that confidentiality of notification information is high, and the notification target is the user A. Here, in the projectable area 21, there is an area within the visible range 40A of the user A and outside the visible ranges 40B and 40C of the users B and C. Therefore, the output control unit 155 sets the projection target area 22 in the area described above. In the example illustrated in FIG. 8, the projection target area is set at a location on the wall 31C. Since the projection target area 22 is already in the current projectable area 21, it is possible to project the notification information without changing the posture of the projector 121.

In a case where the projector 121 has a zoom function, the output control unit 155 may cause the projector 121 to zoom out to expand the projectable area 21. As a result, it becomes possible to increase choices of locations for setting the projection target area.

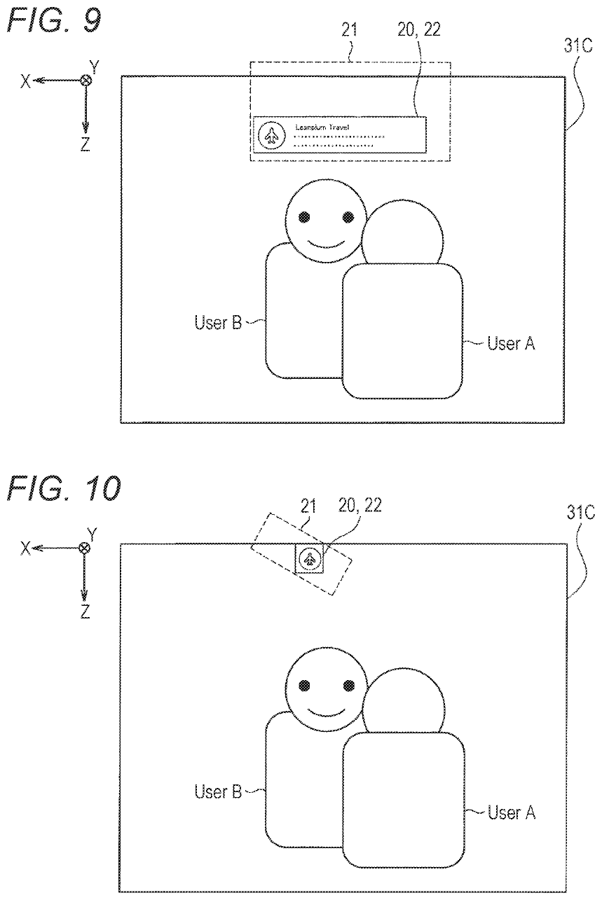

Furthermore, the output control unit 155 may control the content of the notification information to be projected according to the position and/or size of the projection target area. This point will be described with reference to FIGS. 9 and 10.

FIG. 9 is a diagram for explaining an example in which notification information is projected in the second case according to the present embodiment. FIG. 9 illustrates a state of viewing the front side from the back side of the user A (that is, viewing the Y axis positive side from the Y axis negative side) in FIG. 8. As illustrated in FIG. 9, since the area where the projectable area 21 and the wall 31C overlap with each other is relatively large, the projection target area 22 has a size large enough for notification information including an icon and character information to be projected as it is. Therefore, the output control unit 155 projects the display object 20 including the icon and the character information on the projection target area 22.

FIG. 10 is a diagram for explaining an example in which notification information is projected in the second case according to the present embodiment. FIG. 10 illustrates a state of viewing the front side from the back side of the user A (that is, viewing the Y axis positive side from the Y axis negative side) in FIG. 8. As illustrated in FIG. 10, since the area where the projectable area 21 and the wall 31C overlap with each other is relatively small, the projection target area 22 is not large enough for the notification information including the icon and the character information to be projected as it is. Therefore, the output control unit 155 projects the display object 20 including only the icon on the projection target area 22.

Furthermore, in a case where there is another output unit 120 (for example, a display device such as a smartphone) at or near the location set as the projection target area, the output control unit 155 may cause the other output unit 120 to output notification information.

<3.3. Third Case>

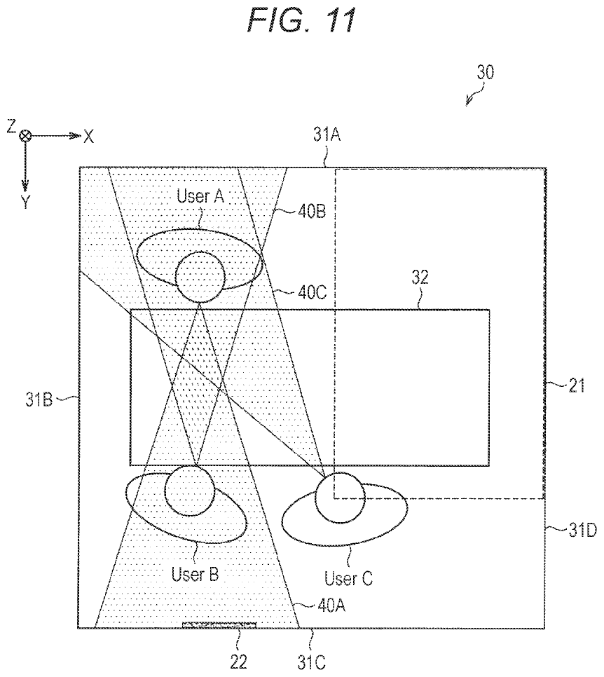

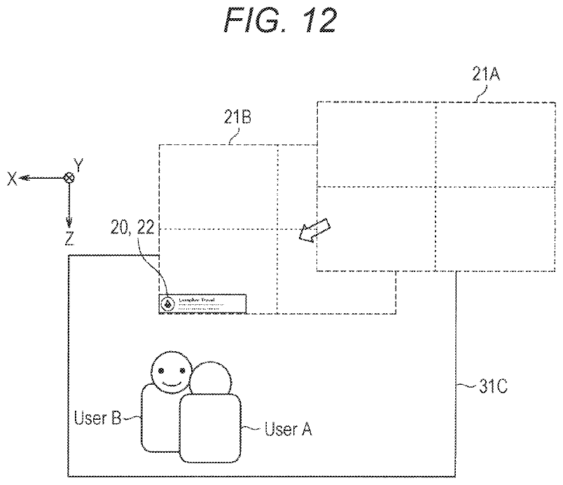

The present case is a case where confidentiality of notification information is high and the projector 121 is driven. The overview of the present case will be described with reference to FIG. 11.

FIG. 11 is a diagram for explaining an overview of a third case according to the present embodiment. As illustrated in FIG. 11, the users A to C are located facing each other around the table 32 in the physical space 30 defined by the walls 31A to 31D. FIG. 11 illustrates a state where the physical space 30 is looked down from above (that is, the Z axis positive side is viewed from the Z axis negative side).

As illustrated in FIG. 11, the current projectable area 21 of the projector 121 includes the floor surface of the physical space 30, the table 32, and the walls 31A and 31D. It is assumed that confidentiality of notification information is high, and the notification target is the user A. Here, in the projectable area 21, there is no area within the visible range 40A of the user A and outside the visible ranges 40B and 40C of the users B and C. Therefore, the output control unit 155 sets the projection target area 22 outside the projectable area 21 on the assumption that the posture is changed. In the example illustrated in FIG. 11, the projection target area 22 is set at a location on the wall 31C. Since the projection target area 22 is outside the current projectable area 21, the notification information is projected after the posture of the projector 121 is changed.

In such a case, in order to ensure confidentiality of the notification information, it is desirable to consider the following viewpoints. Hereinafter, a technology of ensuring confidentiality of the notification information will be described from the viewpoints.

First viewpoint: Minimize drive time

Second viewpoint: Make projection target area less likely to be grasped

Third perspective: Minimize driving sound

Fourth perspective: Reflect behavior of second user

First Viewpoint

The output control unit 155 calculates the minimum posture change amount with which the projection target area can be positioned within the projectable area, and changes the posture of the projector 121 by the calculated change amount. For example, in a case where the projection target area on which notification information is projected is outside the projectable area of the projector 121, the output control unit 155 changes the posture of the projector 121 so that the center of the current projectable area of the projector 121 passes on the direct line connecting the center of the current projectable area of the projector 121 and the projection target area (for example, the center of the projection target area). Specifically, the output control unit 155 sets the projectable area centered on the projection target area as the target projectable area, and determines the drive parameter so that the posture change from the current posture to the target posture becomes linear in a case where the posture that realizes the target projectable area is the target posture. Linear posture change means that the posture change amount per unit time is constant. Such control can minimize the movement distance of the projectable area (that is, the posture change amount of the projector 121). That is, the drive time of the projector 121 can be minimized.

Furthermore, in a case where the projection target area on which notification information is projected is outside the projectable area of the projector 121, the output control unit 155 stops the posture change of the projector 121 with entrance the projection target area into the projectable area of the projector 121 from outside as a trigger. The projection target area being outside the projectable area means that at least part of the projection target area is outside the projectable area. The projection target area being within the projectable area means that entirety of the projection target area is located inside the projectable area. Such posture control can reduce the posture change amount and shorten the drive time as compared with the case where the posture is changed until the projection target area becomes located at the center of the projectable area.

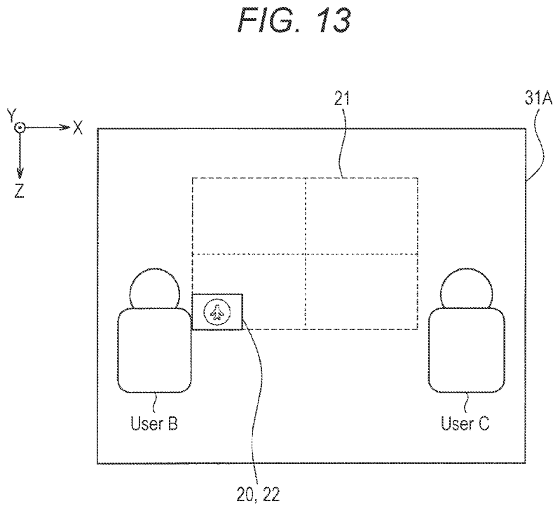

A specific example of the control described above will be described with reference to FIG. 12.

FIG. 12 is a diagram for explaining an example in which notification information is projected in the third case according to the present embodiment. FIG. 12 illustrates a state of viewing the front side from the back side of the user A (that is, viewing the Y axis positive side from the Y axis negative side) in FIG. 11. As described above with reference to FIG. 11, the projection target area 22 is set at a location on the wall 31C. Since the projection target area 22 is outside the current projectable area 21, the notification information is projected after the posture of the projector 121 is changed. It is assumed that the projectable area 21A illustrated in FIG. 12 is the current projectable area of the projector 121. In this case, the projector 121 changes the posture so that the center of the projectable area of the projector 121 passes on the straight line connecting the center of the current projectable area 21A and the projection target area 22. Then, the projector 121 stops the posture change with entrance of the projection target area 22 into the projectable area of the projector 121 from outside as a trigger. The projectable area 21B illustrated in FIG. 12 is a projectable area at the time when the posture change of the projector 121 is stopped. Then, the projector 121 projects the display object 20 generated on the basis of the notification information on the projection target area 22.

Second Viewpoint

Stopping the posture change of the projector 121 according to the trigger described in the first aspect described above is effective also in the second viewpoint. In a case where the posture change of the projector 121 is stopped according to the trigger described above, the projection target area is located at an end part of the projectable area. Therefore, at least the projection target area is located far from the center of the projectable area. Therefore, even if the second user visually recognizes the projector 121 that is projecting the notification information, it is possible to make the second user less likely to grasp where in the projectable area of the projector 121 the notification information is projected.

The output control unit 155 may control the posture of the projector 121 at the time when the notification information is projected such that the center of the projectable area of the projector 121 is between the first user and the second user. The output control unit 155 sets the projection target area for projecting the notification information whose notification target is the first user, in the area on the first user side in the projectable area. In this case, since the projection direction is directed toward the space between the first user and the second user, the position of the projection target area can be less likely to be grasped by the other user. A specific example of such control will be described with reference to FIG. 13.

FIG. 13 is a diagram for explaining an example in which notification information is projected in the third case according to the present embodiment. FIG. 13 illustrates a state of viewing the front side from the back side of the users B and C (that is, viewing the Y axis negative side from the Y axis positive side). It is assumed that confidentiality of the notification information is high, and the notification target is the user B. As illustrated in FIG. 13, it is assumed that the projection target area is set near the front of the user B on the wall 31A. In this case, the output control unit 155 projects the display object 20 generated on the basis of the notification information in such a posture that the center of the projectable area 21 is located between the user B and the user C. As a result, it is possible to make the other user less likely to grasp which side of the user B or C the projection target area 22 is located on and which of the user or C is the notification target.

Third Viewpoint

In a case where confidentiality of the notification information is high, the output control unit 155 may set the posture change speed of the projector 121 to be slower than the posture change speed of the projector 121 in a case where confidentiality of notification information is low. Specifically, the output control unit 155 decreases the posture change speed in a case where the confidentiality is high, and increases the posture change speed in a case where the confidentiality is low. Typically, the faster the posture change speed is, the louder the driving sound of the projector 121 is, and the slower the posture change speed is, the quieter the drive sound of the projector 121 is. Then, the louder the driving sound is, the more easily the second user notices that the projector 121 is driving to change the posture. Therefore, in a case where the confidentiality is high, by decreasing the posture change speed and lowering the driving sound, driving of the projector 121 can be made less noticeable to the second user.

The output control unit 155 may control the posture change speed according to the volume of the environment sound. Specifically, the output control unit 155 increases the posture change speed as the volume of the environmental sound is louder, and decreases the posture change speed as the volume of the environment sound decreases. This is because as the volume of the environmental sound increases, the volume of the driving sound is relatively decreased, and driving of the projector 121 is less noticeable to the second user.

The output control unit 155 may control the posture change speed according to the distance between the projector 121 and the second user. Specifically, the output control unit 155 increases the posture change speed as the distance between the projector 121 and the second user increases, and decreases the posture change speed as the distance decreases. This is because as the distance between the projector 121 and the second user is larger, it becomes harder for the second user to hear the driving sound of the projector 121.

In a case where confidentiality of notification information is high, the output control unit 155 may set the volume of the environment sound around the projector 121 to be louder than the volume of the environment sound around the projector 121 in a case where confidentiality of notification information is low. Specifically, the output control unit 155 increases the volume of the environment sound in a case where the confidentiality is high and decreases the volume of the environment sound in a case where the confidentiality is low. The environmental sound here is, for example, background music (BGM) or the like reproduced in the physical space 30. In a case where the confidentiality is high, by increasing the environment sound and relatively decreasing the volume of the driving sound, driving of the projector 121 can be made less noticeable to the second user.

The output control unit 155 performs control described above on the basis of a sound collection result of a microphone installed in the physical space 30, a sensor device that monitors the operation sound of the projector 121, or the like. Alternatively, the output control unit 155 may perform the control described above by referring to a table set in advance. In a case where the second user is wearing headphones or the like, the control described above may not be performed. Furthermore, the output control unit 155 may set a fan or the like of a main body of the projector 121 as a target for noise reduction.

Fourth Viewpoint

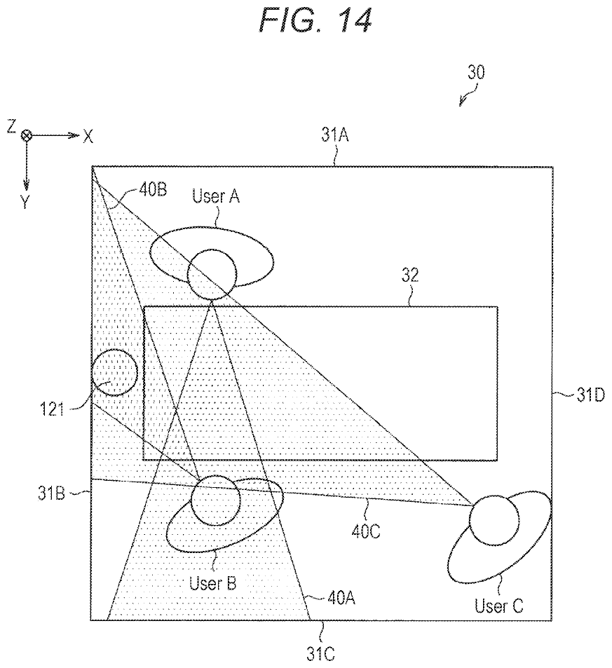

FIG. 14 is a diagram for explaining the posture control in the third case according to the present embodiment. As illustrated in FIG. 14, the users A to C are located facing each other around the table 32 in the physical space 30 defined by the walls 31A to 31D. FIG. 14 illustrates a state where the physical space 30 is looked down from above (that is, the Z axis positive side is viewed from the Z axis negative side). It is assumed that confidentiality of notification information is high, and the notification target is the user A. As illustrated in FIG. 14, the projector 121 is located within the visible ranges 40B and 40C of the users B and C. Therefore, if the projector 121 is driven to change the posture as it is, there is possibility that the users B and C notice that notification information with high confidentiality to the user A is projected.

As a result, in a case where confidentiality of notification information is high, the output control unit 155 imposes a restriction on the posture change of the projector 121 on the basis of user information of the second user. Specifically, in a case where confidentiality of notification information is high, the output control unit 155 selects whether or not to impose a restriction on the posture change of the projector 121 depending on whether or not the projector 121 is located within the visible range of the second user.

In a case where confidentiality of notification information is high, the output control unit 155 may determine whether or not to change the posture of the projector 121 depending on whether or not the projector 121 is located within the visible range of the second user. Specifically, the output control unit 155 does not change the posture of the projector 121 in a case where the projector 121 is located within the visible range of the second user. In contrast, in a case where the projector 121 is located outside the visible range of the second user (that is, a case where the projector 121 is not located within the visible range of the second user), the output control unit 155 changes the posture of the projector 121. Therefore, it is possible to prevent the second user from visually recognizing the state where the projector 121 is being driven. Therefore, it is possible to prevent eyes of the second user from being attracted to the notification information that is projected by using the projection direction of the projector 121 that is being driven as a clue.

In a case where confidentiality of notification information is high, the output control unit 155 may control a noise reduction process of the projector 121 depending on whether or not the projector 121 is located within the visible range of the second user. For example, the output control unit 155 performs the control according to the third viewpoint described above in a case where the projector 121 is located within the visible range of the second user, and does not perform the control in a case where the projector 121 is located outside the range. Alternatively, the output control unit 155 may control the degree of noise reduction (for example, drive speed) depending on whether or not the projector 121 is located within the visible range visible of the second user.

The output control unit 155 may separately notify the first user of notification information with high priority via a personal terminal or a wearable device of the first user. In this case, the first user is notified of the notification information by means of an image, sound, or vibration. In contrast, regarding notification information with low priority, the output control unit 155 may postpone posture control and projection until the condition is satisfied (that is, the projector 121 is out of the visible range of the second user).

Note that the output control unit 155 may determine whether or not to impose a restriction and the content of the restriction without considering the second user far from the projector 121. This is because driving of the projector 121 located far away is less likely to be noticed. The distance serving as a criterion for determining whether or not to be taken into consideration can be set on the basis of the visual acuity of the second user and the size of the projector 121.

Furthermore, the output control unit 155 may determine whether or not to impose a restriction and the content of the restriction without considering the second user with low activity.

Furthermore, in a case where there is another output unit 120 (for example, a display device such as a smartphone) at or near the location set as the projection target area, the output control unit 155 may cause the other output unit 120 to output notification information.

<<4. Process Flow>>

Overall Process Flow

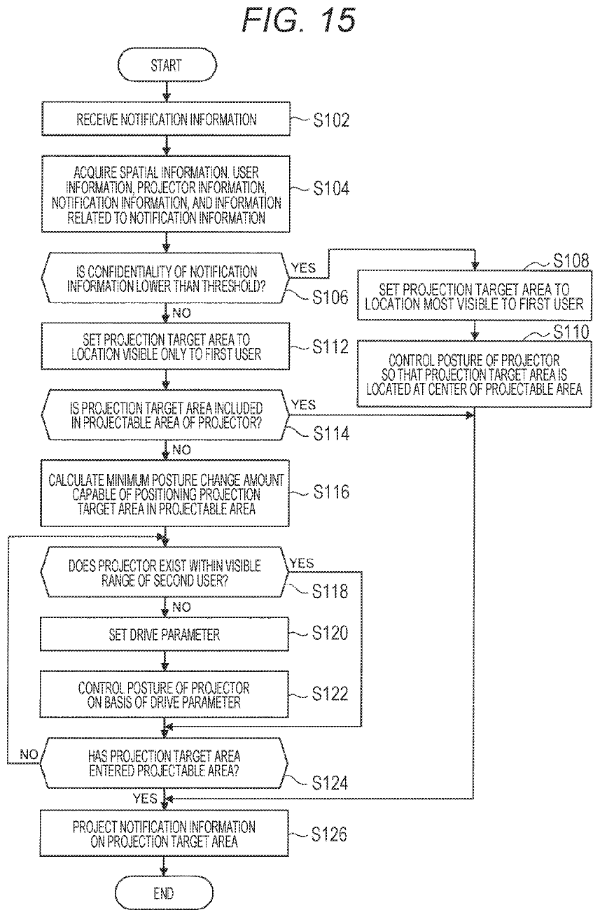

FIG. 15 is a flowchart illustrating an example of the overall flow of a projection process executed by the information processing system 100 according to the present embodiment. As illustrated in FIG. 15, the communication unit 130 receives notification information (step S102). Next, the spatial information acquisition unit 151, the user information acquisition unit 152, the projector information acquisition unit 153, and the notification information acquisition unit 154 acquire spatial information, user information, projector information, notification information, and information related to the notification information (step S104). Next, the output control unit 155 determines whether or not confidentiality of the notification information is lower than a threshold (step S106). The process proceeds to step S108.

In a case where it is determined that the confidentiality of the notification information is lower than the threshold (step S106/YES), the output control unit 155 sets the projection target area at the location which is most visible to the first user (step S108). Next, the output control unit 155 controls the posture of the projector 121 so that the projection target area is located at the center of the projectable area (step S110). Then, the output control unit 155 projects the notification information on the projection target area (step S126). The case where the notification information is projected in this way corresponds to the first case described above.

In a case where it is determined that the confidentiality of the notification information is higher than the threshold (step S106/NO), the output control unit 155 sets the projection target area at a location visible only to the first user (step S112). Next, the output control unit 155 determines whether or not the projection target area is included in the projectable area of the projector 121 (step S114).

In a case where it is determined that the projection target area is included in the projectable area of the projector 121 (step S114/YES), the output control unit 155 projects the notification information on the projection target area (step S126). The case where the notification information is projected in this way corresponds to the second case described above.

In a case where it is determined that the projection target area is included outside the projectable area of the projector 121 (step S114/NO), the output control unit 155 calculates the minimum posture change amount with which the projection target area can be positioned within the projectable area (step S116). Next, the output control unit 155 determines whether or not the projector 121 is within the visible range of the second user (step S118). In a case where it is determined that the projector 121 is within the visible range of the second user (step S118/YES), the process proceeds to step S124. In contrast, in a case where it is determined that the projector 121 is outside the visible range of the second user (step S118/NO), the output control unit 155 sets a drive parameter for changing the posture on the basis of the posture change amount calculated in step S116 described above (step S120). Next, the output control unit 155 controls the posture of the projector 121 on the basis of the drive parameter (step S122). Thereafter, the output control unit 155 determines whether or not the projection target area has entered the projectable area (step S124). In a case where it is determined that the projection target area is not within the projectable area (step S124/NO), the process returns to step S118. In contrast, in a case where it is determined that the projection target area has entered the projectable area (step S124/YES), the output control unit 155 projects the notification information on the projection target area (step S126). The case where the notification information is projected in this way corresponds to the third case described above.

Flow of Posture Control Process in Third Case

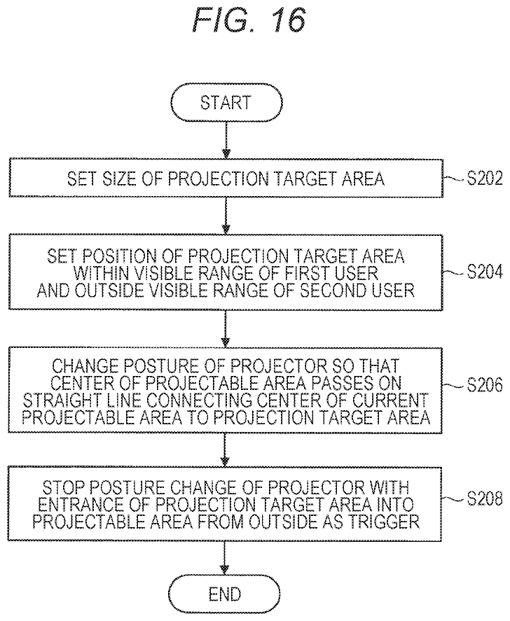

FIG. 16 is a flowchart illustrating an example of a flow of the posture control process in the third case executed by the information processing system 100 according to the present embodiment. As illustrated in FIG. 16, first, the output control unit 155 sets the size of the projection target area on the basis of the content of notification information (step S202). Then, the output control unit 155 sets the position of the projection target area within the visible range of the first user and outside the visible range of the second user, on the basis of user information of the first user, user information of the second user, and spatial information (step S204). Next, the output control unit 155 changes the posture of the projector 121 so that the center of the projectable area of the projector 121 passes on the straight line connecting the center of the current projectable area of the projector 121 and the projection target area (step S206). Then, the output control unit 155 stops the posture change of the projector 121 with entrance of the projection target area into the projectable area of the projector 121 from outside as a trigger (step S208).

<<5. Modifications>>

(1) First Modification

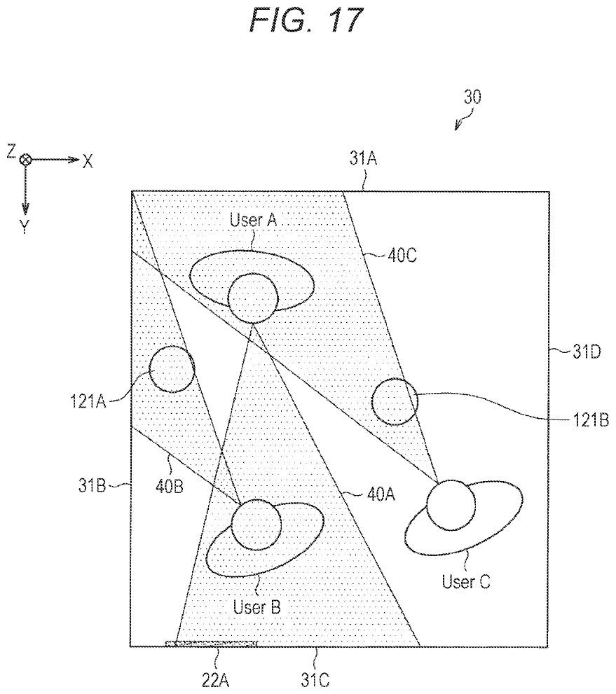

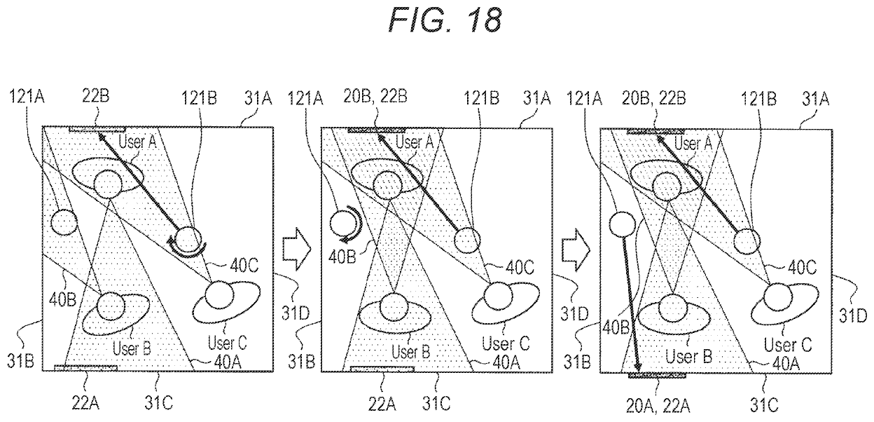

In a case where confidentiality of notification information is high and in a case where the projector 121 is within the visible range of the second user, the output control unit 155 causes another projector 121 to project other notification information whose notification target is the second user in a direction different from the projector 121 as viewed from the second user. In a case where confidentiality of notification information is high, the output control unit 155 first controls two or more projectors 121 and uses one of the projectors 121 for the second user, and then uses the other of the projectors 121 for the first user. Since the line-of-sight of the second user is attracted to the notification information whose notification target is the second user, it is possible to remove the visible range of the second user from the projector 121. Therefore, it is possible to remove the restriction imposed in a case where confidentiality of notification information is high and the projector 121 is within the visible range of the second user. This point will be described in detail with reference to FIGS. 17 and 18.

FIG. 17 is a diagram for explaining a projection process according to the modification. As illustrated in FIG. 17, the users A to C are located facing each other in the physical space 30 defined by the walls 31A to 31D, and projectors 121A and 121B are installed. FIG. 17 illustrates a state where the physical space 30 is looked down from above (that is, the Z axis positive side is viewed from the Z axis negative side). As illustrated in FIG. 17, the projector 121A is located within the visible range 40B of the user B. It is assumed that the information processing system 100 receives notification information with high confidentiality whose notification target is the user A. Then, the projection target area 22A for the notification information whose notification target is the user A is assumed to locate outside the projectable area of the projector 121A. In this case, although it is necessary to drive the projector 121A, the projector 121A is located within the visible range 40B of the user B. Therefore, a restriction is imposed on driving of the projector 121A. Furthermore, it is assumed that the information processing system 100 receives notification information with low confidentiality whose notification target is the user B.

The process performed in this case will be described with reference to FIG. 18. FIG. 18 is a diagram for explaining posture control according to the modification. FIG. 18 illustrates the state of performing the process of removing the visible range 40B of the user B from the projector 121A under the situation illustrated in FIG. 17.

Specifically, as illustrated in the left diagram of FIG. 18, first, the output control unit 155 sets the projection target area 22B for the notification information whose notification target is the user B, and changes the posture of the projector 121B until the projection target area 22B enters the projectable area of the projector 121B. However, the output control unit 155 sets the projection target area 22B at a location where the projector 121A is out of the visible range 40B of the user B in a case where the user B turns his or eyes to the notification information whose notification target is the user B. Here, the projector 121B is located within the visible range 40C of the user C. Since the confidentiality of the notification information whose notification target is the user B is low, it is permissible for the user C to visually recognize the state where the projector 121B is being driven.

Next, as illustrated in the center diagram of FIG. 18, the output control unit 155 projects the display object 20B generated on the basis of the notification information whose notification target is the user B is on the projection target area 22B. In a case where the projection target area 22B is within the visible range 40B of the user B, the eyes of the user B are attracted to the display object 20B projected on the projection target area 22B. If not, by projecting the display object 20B so as to move to the projection target area 22B while traversing the visible range of the user B, the output control unit 155 may cause the eyes of the user B to be attracted to the location of the projection target area 22B. In addition, the output control unit 155 may cause the eyes of the user B to be attracted to the display object 20B projected on the projection target area 22B by performing audio output or the like. As a result, the projector 121A is out of the visible ranges 40B and 40C of the users B and C. Thereafter, the output control unit 155 changes the posture of the projector 121A until the projection target area 22A enters the projectable area of the projector 121A.

Then, as illustrated in the right diagram of FIG. 18, the output control unit 155 causes the projection target area 22A to project the display object 20A generated on the basis of the notification information whose notification target is the user A. Since the display object 20B diverts the attention of the users B and C from the projector 121A, it is possible to make the fact that the X display object 20A with high confidentiality for the user A is projected less noticeable to the users B and C.

Note that, in the above, the example has been described in which notification information with low confidentiality, out of notification information with high confidentiality and the notification information with low confidentiality, is used to secure the confidentiality of the notification information with high confidentiality. The output control unit 155 may rank relative confidentiality of pieces of notification information that have been received and have not been conveyed, so that notification is performed in ascending order of confidentiality of each piece of the notification information in the same manner as described above to secure confidentiality of notification information with relatively high confidentiality.

Furthermore, in a case where there is a plurality of projectors 121, the output control unit 155 selects a projector existing outside the visible range of the second user as the projector 121 that projects notification information whose notification target is the first user. In this case, it becomes possible to notify the first user of notification information with high confidentiality without performing the process of removing the visible range of the second user from the projector 121.

(2) Second Modification

The output control unit 155 may change the posture of the projector 121 and project the notification information, and then return the posture of the projector 121 to a predetermined posture. The predetermined posture may be a posture before the posture is changed or may be an initial posture set in advance. As a result, the history of posture changes is deleted. Therefore, it is possible to prevent the second user from noticing that the first user has been notified of notification information after projection of the notification information is finished.

(3) Third Modification

The output control unit 155 may darken an indicator such as an LED for displaying energization or the like of the projector 121 during driving of the projector 121. As a result, driving of the projector 121 can be made less noticeable to the second user.

(4) Fourth Modification

The output control unit 155 may control the posture of the projector 121 or environment light around the projector 121 (for example, room lighting) so that the area whose brightness exceeds a predetermined threshold is included in the projectable area of the projector 121, in projection of notification information. In particular, the output control unit 155 controls the posture of the projector 121 or the environment light so that the brightness of the area other than the projection target area in the projectable area exceeds the predetermined threshold. The projector 121 can project a solid black color on the portion other than the projection target area in the projectable area. This solid black portion can be visually recognized by the second user. In this respect, by performing this control, the solid black portion can be made inconspicuous.

(5) Fifth Modification

The output control unit 155 may drive the projector 121 located within the visible range of the first user instead of performing projection. In this case, it is possible to notify the first user of the fact that there is at least notification information for the first user.

<<6. Summary>>

An embodiment of the present disclosure has been described above in detail with reference to FIGS. 1 to 18. As described above, the information processing system 100 according to the present embodiment controls the projection process of notification information including posture control of the projector 121 on the basis of spatial information of the physical space 30, projector information, confidentiality information, user information of the first user, and user information of the second user. The information processing system 100 can notify the first user of at least notification information to the first user so that the first user can visually recognize the notification information by controlling the projection process on the basis of the spatial information and the user information of the first user. Furthermore, the information processing system 100 controls the projection process on the basis of the projector information, the confidentiality information, and the user information of the second user. Therefore, the information processing system 100 can control the posture of the projector 121 according to confidentiality of the notification information that the first user is notified of.

More specifically, in a case where confidentiality of the notification information is high, the information processing system 100 controls as to whether or not to impose a restriction on driving of the projector 121 according to whether or not the projector 121 is located within the visible range of the second user. For example, the output control unit 155 does not change the posture of the projector 121 in a case where the projector 121 is located within the visible range of the second user, and changes the posture of the projector 121 in a case where the projector 121 is located outside the visible range of the second user. Therefore, it is possible to prevent the second user from visually recognizing the state where the posture of the projector 121 is changed. Therefore, it is possible to prevent the eyes of the second user from being attracted to notification information.

While a preferred embodiment of the present disclosure has been described in detail with reference to the accompanying drawings, the technical scope of the present disclosure is not limited to such examples. It is obvious that a person skilled in the art to which the present disclosure pertains can conceive various modifications and corrections within the scope of the technical idea described in the claims, and it is naturally understood that these also belong to the technical scope of the present disclosure.

For example, the information processing system 100 may be realized as a single device, or part or all of the information processing system 100 may be realized as separate devices. For example, in the functional configuration example of the information processing system 100 illustrated in FIG. 2, the communication unit 130, the storage unit 140, and the control unit 150 may be included in a device such as a server connected to the input unit 110 and the output unit 120 via a network or the like.

Note that the series of processes performed by each device described in the present Description may be realized by using any of software, hardware, and a combination of software and hardware. The program configuring the software is stored in advance in a storage medium (non-transitory media) provided inside or outside each device, for example. Then, each program is read into the RAM, for example, when the computer executes the program, and is executed by a processor such as a CPU. The storage medium described above is, for example, a magnetic disk, an optical disk, a magneto-optical disk, a flash memory, or the like. Furthermore, the computer program described above may be distributed, for example, via a network without using a storage medium.

Furthermore, the processes described in the present Description by using the flowcharts and the sequence diagrams does not necessarily have to be executed in the illustrated order. Some process steps may be performed in parallel. In addition, additional process steps may be adopted, and some process steps may be omitted.

Furthermore, the effects described in the present Description are illustrative or exemplary only and are not limited. That is, the technology according to the present disclosure can exhibit other effects that are apparent to those skilled in the art from the description of the present Description in addition to or in lieu of the effects described above.

Note that the following configurations also belong to the technical scope of the present disclosure.

(1)

An information processing apparatus including a control unit configured to control a projection process of notification information including posture control of a projection device on the basis of spatial information of a space where the projection device can perform projection, information indicating the position and the posture of the projection device, information indicating confidentiality of the notification information, information of a first user who is a notification target of the notification information, and information of a second user who is not a notification target of the notification information.

(2)

The information processing apparatus according to (1), in which the control unit imposes a restriction on a change in the posture of the projection device in a case where the information indicating the confidentiality satisfies a predetermined condition.

(3)

The information processing apparatus according to (2), in which the control unit determines whether or not to change the posture of the projection device according to whether or not the projection device is located within a visible range of the second user.

(4)

The information processing apparatus according to (3), in which the control unit does not change the posture of the projection device in a case where the projection device is located within the visible range of the second user, and changes the posture of the projection device in a case where the projection device is located outside the visible range of the second user.

(5)

The information processing apparatus according to (4), in which in a case where a projection target area where the notification information is projected is outside a projectable area of the projection device, the control unit changes the posture of the projection device so that a center of a projectable area of the projection device passes on a straight line connecting a center of a current projectable area of the projection device and the projection target area.

(6)

The information processing apparatus according to (4) or (5), in which in a case where a projection target area where the notification information is projected is outside a projectable area of the projection device, the control unit stops a posture change of the projection device with entrance of the projection target area into the projectable area of the projection device from outside as a trigger.

(7)

The information processing apparatus according to any one of (2) to (6), in which the predetermined condition is that the information indicating the confidentiality indicates that the notification information is information that should be kept confidential.

(8)

The information processing apparatus according to any one of (1) to (7), in which the control unit controls the posture of the projection device in projection of the notification information so that the center of the projectable area of the projection device is located between the first user and the second user.

(9)

The information processing apparatus according to any one of (1) to (8), in which the control unit causes another projection device to project other notification information whose notification target is the second user in a direction different from the projection device as viewed from the second user in a case where the projection device is within a visible range of the second user.

(10)

The information processing apparatus according to any one of (1) to (9), in which in a case where the information indicating the confidentiality satisfies a predetermined condition, the control unit sets posture change speed of the projection device to be slower than posture change speed of the projection device in a case where the information indicating the confidentiality does not satisfy the predetermined condition.

(11)

The information processing apparatus according to any one of (1) to (10), in which in a case where the information indicating the confidentiality satisfies a predetermined condition, the control unit sets a volume of environment sound around the projection device to be louder than a volume of environment sound around the projection device in a case where the information indicating the confidentiality does not satisfy the predetermined condition.

(12)

The information processing apparatus according to any one of (1) to (11), in which in a case where the information indicating the confidentiality satisfies a predetermined condition, the control unit changes the posture of the projection device to project the notification information and then returns the posture of the projection device to a predetermined posture.

(13)

The information processing apparatus according to any one of (1) to (12), in which the control unit controls the posture of the projection device or environment light around the projection device so that an area whose brightness exceeds a predetermined threshold is included in a projectable area of the projection device in projection of the notification information.

(14)

The information processing apparatus according to any one of (1) to (13), in which the control unit sets a projection target area where the notification information is projected within a visible range of the first user and outside a visible range of the second user in a case where the information indicating the confidentiality satisfies a predetermined condition.

(15)

The information processing apparatus according to any one of (1) to (14), in which the control unit causes the projection device to project the notification information without changing or by changing the posture of the projection device.

(16)

The information processing apparatus according to any one of (1) to (15), in which the information of the second user includes information indicating activity of the second user.

(17)

An information processing method including causing a processor to control a projection process of notification information including posture control of a projection device on the basis of spatial information of a space where the projection device can perform projection, information indicating the position and the posture of the projection device, information indicating confidentiality of the notification information, information of a first user who is a notification target of the notification information, and information of a second user who is not a notification target of the notification information.

(18)

A program for causing a computer to function as a control unit configured to control a projection process of notification information including posture control of a projection device on the basis of spatial information of a space where the projection device can perform projection, information indicating the position and the posture of the projection device, information indicating confidentiality of the notification information, information of a first user who is a notification target of the notification information, and information of a second user who is not a notification target of the notification information.

### REFERENCE SIGNS LIST

100 Information processing system
110 Input unit
120 Output unit
121 Projection device, Projector
130 Communication unit
140 Storage unit
150 Control unit
151 Spatial information acquisition unit
152 User information acquisition unit
153 Projector information acquisition unit
154 Notification information acquisition unit
155 Output control unit

1. An information processing apparatus comprising
a control unit configured to control a projection process of notification information including posture control of a projection device on a basis of spatial information of a space where the projection device can perform projection, information indicating a position and a posture of the projection device, information indicating confidentiality of the notification information, information of a first user who is a notification target of the notification information, and information of a second user who is not a notification target of the notification information.

2. The information processing apparatus according to claim 1, wherein the control unit imposes a restriction on a change in the posture of the projection device in a case where the information indicating the confidentiality satisfies a predetermined condition.

3. The information processing apparatus according to claim 2, wherein the control unit determines whether or not to change the posture of the projection device according to whether or not the projection device is located within a visible range of the second user.

4. The information processing apparatus according to claim 3, wherein the control unit does not change the posture of the projection device in a case where the projection device is located within the visible range of the second user, and changes the posture of the projection device in a case where the projection device is located outside the visible range of the second user.

5. The information processing apparatus according to claim 4, wherein in a case where a projection target area where the notification information is projected is outside a projectable area of the projection device, the control unit changes the posture of the projection device so that a center of the projectable area of the projection device passes on a straight line connecting a center of a current projectable area of the projection device and the projection target area.

6. The information processing apparatus according to claim 4, wherein in a case where a projection target area where the notification information is projected is outside a projectable area of the projection device, the control unit stops a posture change of the projection device with entrance of the projection target area into the projectable area of the projection device from outside as a trigger.

7. The information processing apparatus according to claim 2, wherein the predetermined condition is that the information indicating confidentiality indicates that the notification information is information that should be kept confidential.

8. The information processing apparatus according to claim 1, wherein the control unit controls the posture of the projection device in projection of the notification information so that a center of a projectable area of the projection device is located between the first user and the second user.

9. The information processing apparatus according to claim 1, wherein the control unit causes another projection device to project other notification information whose notification target is the second user in a direction different from the projection device as viewed from the second user in a case where the projection device is within a visible range of the second user.

10. The information processing apparatus according to claim 1, wherein in a case where the information indicating the confidentiality satisfies a predetermined condition, the control unit sets posture change speed of the projection device to be slower than posture change speed of the projection device in a case where the information indicating the confidentiality does not satisfy the predetermined condition.

11. The information processing apparatus according to claim 1, wherein in a case where the information indicating the confidentiality satisfies a predetermined condition, the control unit sets a volume of environment sound around the projection device to be louder than a volume of environment sound around the projection device in a case where the information indicating the confidentiality does not satisfy the predetermined condition.

12. The information processing apparatus according to claim 1, wherein in a case where the information indicating the confidentiality satisfies a predetermined condition, the control unit changes the posture of the projection device to project the notification information and then returns the posture of the projection device to a predetermined posture.

13. The information processing apparatus according to claim 1, wherein the control unit controls the posture of the projection device or environment light around the projection device so that an area whose brightness exceeds a predetermined threshold is included in a projectable area of the projection device in projection of the notification information.

14. The information processing apparatus according to claim 1, wherein in a case where the information indicating the confidentiality satisfies a predetermined condition, the control unit sets a projection target area where the notification information is projected within a visible range of the first user and outside a visible range of the second user.

15. The information processing apparatus according to claim 1, wherein the control unit causes the projection device to project the notification information without changing or by changing the posture of the projection device.

16. The information processing apparatus according to claim 1, wherein the information of the second user includes information indicating activity of the second user.

17. An information processing method comprising
causing a processor to control a projection process of notification information including posture control of a projection device on a basis of spatial information of a space where the projection device can perform projection, information indicating a position and a posture of the projection device, information indicating confidentiality of the notification information, information of a first user who is a notification target of the notification information, and information of a second user who is not a notification target of the notification information.

18. A program for causing a computer
to function as a control unit configured to control a projection process of notification information including posture control of a projection device on a basis of spatial information of a space where the projection device can perform projection, information indicating a position and a posture of the projection device, information indicating confidentiality of the notification information, information of a first user who is a notification target of the notification information, and information of a second user who is not a notification target of the notification information.
